(19) United States
(12) Patent Application Publication
(10) Pub. No.: US 2004/0069262 A1
(43) Pub. Date: Apr. 15, 2004

(54) Exhaust valve guide for engines

(76) Inventors: Kenji Mihara, Oyama-City (JP); Hiroshi Tsuda, Oyama-City (JP)

Correspondence Address: VARNDELL & VARNDELL, PLLC, 106-A S. COLUMBUS ST., ALEXANDRIA, VA, 22314, US

(21) Appl. No.: 10/655,128

(22) Filed: Sep. 5, 2003

(30) Foreign Application Priority Data
Sep. 9, 2002 (JP) 2002-263207

(51) Int. Cl. F02N 3/00

(52) U.S. Cl. 123/188.9

(57) ABSTRACT

An exhaust valve guide for engines which is not corroded with SOx contained in an exhaust gas from an engine in which EGR is carried out, or from an engine using a fuel of a high sulfur content. A tubular member of the exhaust valve guide is press-fitted in a receiving hole of a cylinder head. A valve stem of an exhaust valve is slidably inserted into a shaft hole of the tubular member. An inner side of the shaft hole of the exhaust valve guide is surface treated with a material having a corrosion resistance and an abrasion resistance. The tubular member is made of, for example, regular cast iron, and the surface treatment operations using a material having a corrosion resistance and an abrasion resistance include, for example, Cr plating, Mo flame spraying, Ni plating.

### BACKGROUND OF THE INVENTION

1. Field of the Invention

This invention relates to an exhaust valve guide for engines, and more particularly to an exhaust valve guide for engines in which EGR is carried out and for engines running under high exhaust temperature and for engines using a fuel of a high sulfur content.

2. Description of the Related Art

A comparatively easily processable soft metal has heretofore been used for a valve guide for engines. Therefore, such a valve guide is readily worn and corroded during an operation of an engine, and a clearance increases between a shaft hole of the valve guide and a valve stem to cause an oil-containing gas and smoke to be discharged to the outside. Under the circumstances, various kinds of measures to prevent the valve guide from being worn and corroded have been taken (for example, refer to the patent literature 1, i.e. JP-A-56-110505, page 2, FIG. 1).

FIG. 6 is a sectional view of a valve guide for internal combustion engines disclosed in the patent literature 1. Referring to FIG. 6, a valve guide 10 is provided with a tubular member 11 and a flange which are made of a hard metal. The valve guide 10 is press-fitted in a receiving hole 16 provided in a cylinder head 15. In a lower wall of the cylinder head 15, a suction or exhaust port 22 is provided. A reference numeral 20 denotes a suction or exhaust valve, and a valve stem 21 thereof is slidably inserted into a shaft hole 13 of the valve guide 10. A whole outer side surface 14 except the shaft hole 13 is plated with bronze. An inner circumferential surface of the shaft hole 13 is nitrified. The valve guide 10 is processed as a finished part, and then press-fitted in the receiving hole 16 of the cylinder head 15.

In recent years, a method of reducing NOx contained in an exhaust gas by a method usually called EGR for recirculating an exhaust gas from an engine to an intake side so as to reduce NOx gas has been employed. In an engine in which this EGR is carried out, or in an engine using a fuel of a high sulfur content, the corrosion of the engine is accelerated due to SOx contained in an exhaust gas. This phenomenon occurs extremely, especially, on the portion of an exhaust valve guide which is in the vicinity of an exhaust port. Referring to FIG. 6, an exhaust gas containing SOx flows into the exhaust port 22 in the direction of an arrow, and corrodes the shaft hole 13 of the valve guide 10.

### SUMMARY OF THE INVENTION

The present invention has been made with the inventor's attention paid to these problems, and aims at providing an exhaust valve guide for engines which is not corroded with SOx contained in an exhaust gas from an engine in which EGR is carried out, or from an engine using a fuel of a high sulfur content.

To achieve this object, a first invention provides an exhaust valve guide for engines in which an inner side surface of a shaft hole thereof is formed out of a material having a corrosion resistance.

According to the first invention, the inner side surface of the shaft hole of the exhaust valve guide is formed out of a material having a corrosion resistance, so that the corrosion of an exhaust valve guide ascribed to SOx contained in an exhaust gas can be prevented in an engine in which EGR is carried out, and in an engine using a fuel of a high sulfur content.

A second invention is in accordance with the first invention, in which the inner side of the shaft hole of the exhaust valve guide is surface treated.

According to the second invention, the inner side of the shaft hole of the exhaust valve guide is surface treated, so that the corrosion of the exhaust valve guide with SOx contained in the exhaust gas can be prevented. Moreover, a finished exhaust valve guide can be press-fitted in the cylinder head of the engine. Therefore, the manufacturing of the exhaust valve guide becomes easy, and the reduction of the manufacturing cost can be reduced.

A third invention is in accordance with the first or second invention, in which the portion of a predetermined length of the inner side of the shaft hole which extends in the longitudinal direction of the exhaust valve guide, and which is on the side of the exhaust port, is surface treated.

According to the third invention, the portion of a predetermined length of the inner side of the shaft hole which extends in the longitudinal direction of the exhaust valve guide, and which is on the side of the exhaust port, is surface treated. The corrosion and abrasion of the exhaust valve guide occur mainly on the portion of the inner surface thereof which is on the side of the exhaust port. Therefore, when the portion of a predetermined length of the inner side of the shaft hole which is on the side of the exhaust port is surface treated, the object can be achieved sufficiently. In this invention, the portion of the inner surface of the shaft hole to be surface treated is shortened, so that the cost of manufacturing the exhaust valve guide can be reduced.

A fourth invention is in accordance with the first invention, in which the exhaust valve guide is made of a two-layer structure of sintered metals.

According to the fourth invention, the exhaust valve guide is made of a two-layer structure of sintered metals, so that the valve guide can be formed into a valve guide having a corrosion resistance, a lubricating ability and an abrasion resistance. Moreover, the inner surface of the exhaust valve guide can be processed after the valve guide is press-fitted into the cylinder head, and an exhaust valve guide of a high accuracy can therefore be obtained.

A fifth invention is an exhaust valve guide formed by dividing the valve guide into a longitudinally extending upper portion and a longitudinally extending lower, exhaust port-side portion of a predetermined length, the lower portion being made of a material having a corrosion resistance.

According to the fifth invention, the exhaust valve guide is divided into two longitudinally extending portions, and a necessary divisional portion only is made of a corrosion resisting material. Therefore, the corrosion of the valve guide can be prevented, and the material cost decreases. Moreover, the inner surface of the exhaust valve guide can be processed after the valve guide is press-fitted into the cylinder head, and an exhaust valve of a high accuracy is therefore obtained.

A sixth invention is in accordance with the fifth invention, in which the lower portion of the exhaust valve guide is made of a two-layer structure of corrosion resisting sintered materials so that the inner surface side of the shaft hole is made a material having a corrosion resistance.

According to the sixth invention, the exhaust valve guide can be formed into an exhaust valve guide having a corrosion resistance, a lubricating ability and an abrasion resistance. Moreover, the inner surface of the exhaust valve body can be processed after the exhaust valve guide is press-fitted into the cylinder head, and an exhaust valve guide of a high accuracy is therefore obtained. Moreover, since the necessary divisional portion only is made of a two-layer structure of sintered materials, the manufacturing cost can be reduced.

A seventh invention is in accordance with the first to sixth inventions, in which the material having a corrosion resistance also has an abrasion resistance.

According to the seventh invention, an exhaust valve guide having a corrosion resistance and an abrasion resistance is obtained, and the durability of the engine can be improved.

### BRIEF DESCRIPTION OF THE DRAWINGS

Preferred embodiments of the present invention will now be described with reference to the accompanying drawings, wherein:

FIG. 1 is a sectioned side view of a first mode of embodiment of the present invention;

FIG. 2 is a sectioned side view of a second mode of embodiment of the present invention;

FIG. 3 is a sectioned side view of a third mode of embodiment of the present invention;

FIG. 4 is a sectioned side view of a fourth mode of embodiment of the present invention;

FIG. 5 is a sectioned side view of a fifth mode of embodiment of the present invention; and

FIG. 6 is a sectional view of a related art valve guide for internal combustion engines.

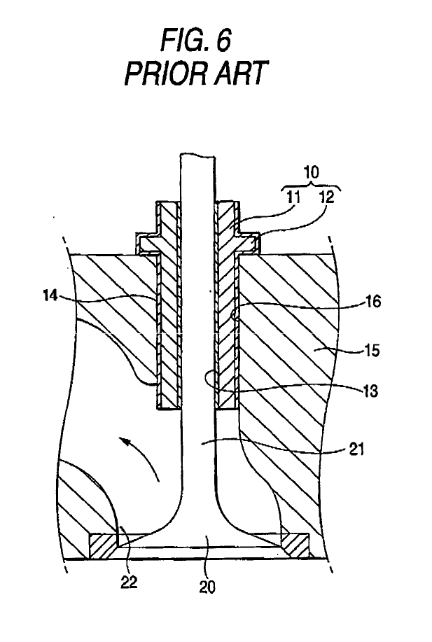

### DESCRIPTION OF THE PREFERRED EMBODIMENTS

The modes of embodiment of the exhaust valve guide for engines according to the present invention will now be described in detail with reference to the drawings.

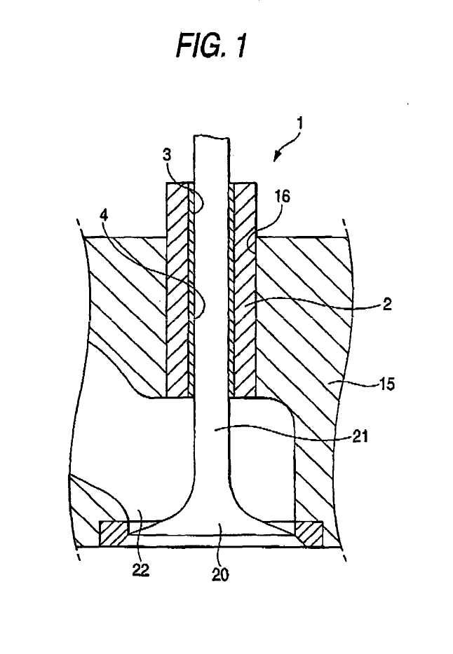

FIG. 1 is a sectioned side view of an exhaust valve guide 1 in the first mode of embodiment. Referring to FIG. 1, a tubular member 2 of the exhaust valve guide 1 is press-fitted into a receiving hole 16 provided in a cylinder head 15. An exhaust port 22 is provided in a lower wall of the cylinder head 15. A valve stem 21 of an exhaust valve is slidably inserted into a shaft hole 3 of the exhaust valve guide 1. An inner surface of the shaft hole 3 is treated with a material having a corrosion resistance and an abrasion resistance. The tubular member is made of, for example, regular cast iron, and a surface treatment for the material having a corrosion resistance and an abrasion resistance includes, for example, Cr plating, Mo flame spraying, Ni plating, flame spraying of a ceramic material and the like. The exhaust valve guide 1 is set in the cylinder head 15 after the valve guide is finished as a completed part.

Since the exhaust valve guide 1 according to the present invention is formed as described above, the corrosion of the valve guide 1 with the SOx contained in an exhaust gas can be prevented even in an engine using a fuel having a high sulfur content. At the same time, the abrasion resistance of the valve guide can be improved, and the durability thereof can also be improved. Moreover, the valve guide can be set as a finished part in the cylinder head, and manufactured easily, so that the manufacturing cost can be reduced.

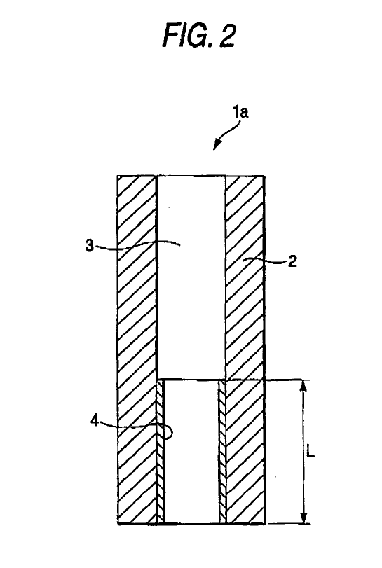

FIG. 2 is a sectioned side elevation of an exhaust valve guide 1a in a second mode of embodiment. Referring to FIG. 2, the portion on the side of an exhaust port 22 of an inner surface 4 of a shaft hole 3 of a tubular member 2 which extends to a predetermined length L is surface treated with a material having a corrosion resistance. The exhaust guide valve is readily corroded at the portion thereof which is on the side of the exhaust port 22, and the temperature of the exhaust valve increases to cause the abrasion thereof to be promoted, so that improving the corrosion resistance and abrasion resistance of the portion of the cylinder head which is in the vicinity of the exhaust port 22 is effective. The length L is, for example, 20 to 30 mm. Since the respective materials are identical with those used in the first mode of embodiment, a description therefor will be omitted. According to this mode of embodiment, the length of the portion of the inner side surface of the shaft hole which is surface treated is small, the manufacturing cost can be reduced.

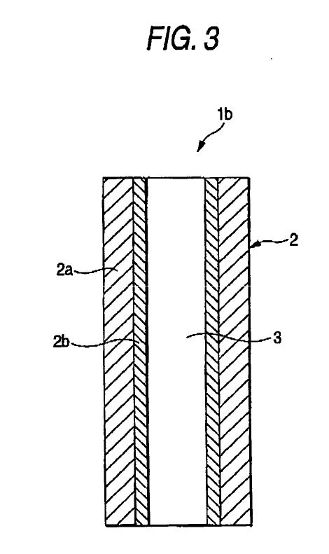

FIG. 3 is a sectioned side view of an exhaust valve guide 1b in a third mode of embodiment. Referring to FIG. 3, a tubular member 2 is made of a two-layer structure of sintered materials and includes an outer circumferential portion 2a of regular cast iron, and an inner circumferential portion 2b of a material having a corrosion resistance and an abrasion resistance. The sintered materials having a corrosion resistance and an abrasion resistance include, for example, a hard particle-containing steel-infiltrated iron-based sintered alloy which is a sintered alloy made of iron containing carbon, chromium, molybdenum, cobalt, nickel and copper. Since this sintered alloy has a corrosion resistance and an abrasion resistance, the durability of the exhaust valve guide is improved. Moreover, the processing of the inner surface of a shaft hole 3 can be done after the exhaust valve guide is press-fitted in a cylinder head, and the accuracy of the parts relating to a valve can be improved.

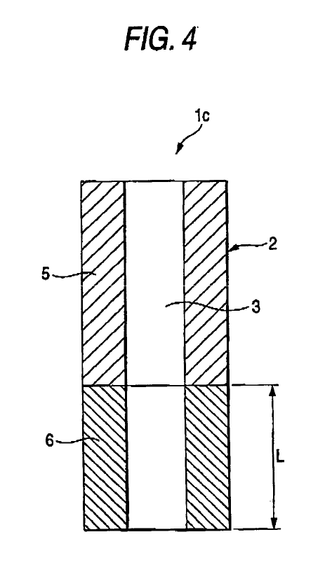

FIG. 4 is a sectioned side view of an exhaust valve guide 1c in a fourth mode of embodiment. Referring to FIG. 4, a tubular member 2 is divided into two longitudinal parts, i.e. an upper portion 5, and a lower portion 6 of a length L on the side of an exhaust port 22. The upper portion 5 is made of regular cast iron, and the lower portion 6 a material having a corrosion resistance and an abrasion resistance. The upper portion 5 and lower portion 6 are press-fitted into a cylinder head with these portions left separated. A shaft hole 3 may thereafter be processed, and the upper portion 5 and lower portion 6 may be combined together by bonding or by friction welding.

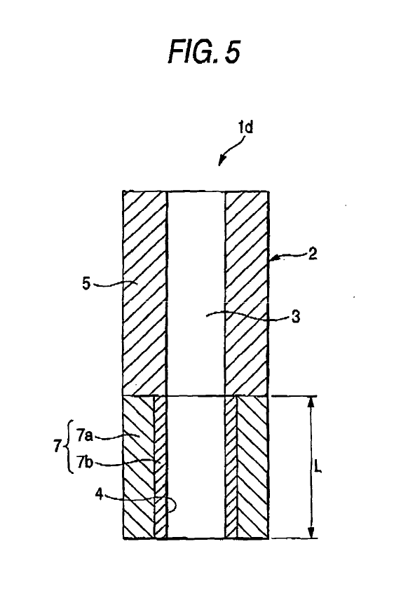

FIG. 5 is a sectioned side view of an exhaust valve guide 1d in a fifth mode of embodiment. Referring to FIG. 5, a tubular member is divided into two longitudinal parts, i.e. an upper portion 5, and a lower portion 7 of a length L on the side of an exhaust port 22. The lower portion 7 is made of a two-layer structure of sintered materials and includes an outer circumferential portion 7a of regular cast iron, and an inner circumferential portion 7b of a material having a corrosion resistance and an abrasion resistance. The sintered materials are identical with those used in the third mode of embodiment. In the same manner as in the fourth mode of embodiment, the upper portion 5 and lower portion 7 are press-fitted in a cylinder head with these portions left separated. A shaft hole 3 may thereafter be processed, and the upper portion 5 and lower portion 7 may be combined together by bonding or by friction welding and the like. According to this mode of embodiment, the portion of sintered materials is of a small length, so that a decrease in the manufacturing cost can be attained.

What is claimed is:

1. An exhaust valve guide for engines, wherein an inner side surface of a shaft hole of the exhaust valve guide is formed out of a material having a corrosion resistance.

2. The exhaust valve guide for engines according to claim 1, wherein the inner side surface of the shaft hole of the exhaust valve guide is surface treated.

3. The exhaust valve guide for engines according to claim 1, wherein a portion of a predetermined length of the inner side surface of the shaft hole which extends in a longitudinal direction of the exhaust valve guide, and which is on the side of an exhaust port, is surface treated.

4. The exhaust valve guide for engines according to claim 2, wherein a portion of a predetermined length of the inner side surface of the shaft hole which extends in a longitudinal direction of the exhaust valve guide, and which is on the side of an exhaust port, is surface treated.

5. The exhaust valve guide for engines according to claim 1, wherein the exhaust valve guide is made of a two-layer structure of sintered materials.

6. The exhaust valve guide for engines, wherein the exhaust valve guide is comprised with a longitudinally extending upper portion, and a longitudinally extending lower, exhaust port-side portion of a predetermined length, the lower portion being made of a material having a corrosion resistance.

7. The exhaust valve guide for engines according to claim 6, wherein the lower portion is made of a two-layer structure of sintered materials with the inner side surface of the shaft hole having a corrosion resistance.

8. The exhaust valve guide for engines according to claim 1, wherein the material having a corrosion resistance also has an abrasion resistance.

9. The exhaust valve guide for engines according to claim 2, wherein the material having a corrosion resistance also has an abrasion resistance.

10. The exhaust valve guide for engines according to claim 3, wherein the material having a corrosion resistance also has an abrasion resistance.

11. The exhaust valve guide for engines according to claim 4, wherein the material having a corrosion resistance also has an abrasion resistance.

12. The exhaust valve guide for engines according to claim 5, wherein the material having a corrosion resistance also has an abrasion resistance.

13. The exhaust valve guide for engines according to claim 6, wherein the material having a corrosion resistance also has an abrasion resistance.

14. The exhaust valve guide for engines according to claim 7, wherein the material having a corrosion resistance also has an abrasion resistance.
